(19) United States
(12) Patent Application Publication
(10) Pub. No.: US 2009/0023425 A1
(43) Pub. Date: Jan. 22, 2009

(54) SYSTEM AND METHOD FOR MOBILE TERMINATED EVENT COMMUNICATION CORRELATION

(76) Inventors: Syed Zaeem Hosain, San Jose, CA (US); Robert Fultz, Boulder Creek, CA (US); Kirk Brezee, Richmond, CA (US); Byung Hoon Sim, Santa Clara, CA (US); Lotus Lin Weygandt, Los Gatos, CA (US); Dae Seong Kim, Campbell, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/174,853

(22) Filed: Jul. 17, 2008

Related U.S. Application Data
(60) Provisional application No. 60/951,173, filed on Jul. 20, 2007.

(51) Int. Cl. H04M 1/725

(52) U.S. Cl. 455/412.1

(57) ABSTRACT

A system, method, and devices for receiving data communications from a plurality of remote terminals via a Mobile Switching Center, each data communication including a device identifier for an originating remote terminal; selecting a call center to respond to each data communication; sending a message via a side-channel to the selected call center including at least a portion of the data communication; receiving a voice communication from the selected call center responsive to the message via a Public Switched Telephone Network; and routing the voice communication back to the remote terminal associated with the message via the Mobile Switching Center.

### CROSS-REFERENCE TO RELATED APPLICATIONS

This application claims the benefit of U.S. provisional patent application No. 60/951,173 entitled “System and Method for Mobile Terminated Event Communication Correlation,” filed Jul. 20, 2007.

### TECHNICAL FIELD

This invention relates to the field of telephonic communication systems, methods, devices, and more particularly, to a system and method for correlating event communications originating from a call center and terminating at a remote terminal responsive to data communication from the remote terminal.

### BACKGROUND

Event communication correlation is the process of associating an event communication, such as an incoming telephone call from a customer, with additional information associated with the person, entity, or device from which the communication originates. Take for example, a person calling a 9-1-1 call center (e.g. emergency services in the United States) to request assistance. The 9-1-1 call center will attempt to “dispatch” the phone call to the appropriate emergency services provider, such as a local police station, fire department, or ambulance service, based on information from the caller.

The 9-1-1 call center, sometimes called a Public Safety Answering Point (“PSAP”), will attempt to determine events necessitating the phone call, such as a fire or a medical emergency, and obtain further information such as the location of the caller. Some of this information may be obtained systematically in those geographic areas offering “enhanced 9-1-1” to land line subscribers. Enhanced 9-1-1 enables emergency service providers to perform a reverse telephone number lookup on incoming phone calls correlating the incoming caller's phone number with a name and address.

However, enhanced 9-1-1 services are limited in functionality and are not available to every geographic location. For example, emergency callers using mobile or cellular based telephones must orally describe their location to an operator who must then forward the emergency phone call to an appropriate local 9-1-1 call center based on location. All users of 9-1-1 services must orally describe the reasons or events precipitating their phone call, for example, explaining to the operator that there has been a car accident and requesting an ambulance.

Traditional systems are further limited because they require manual intervention to request emergency services. For example, using prior art methods, a victim of a car crash must locate a telephone themselves, dial 9-1-1, describe in detail where the accident took place, and wait for help. Alternatively, an accident victim unable to reach a phone must wait for other potential witnesses to call for help on their behalf. If the accident victim cannot access a phone and witnesses are not available to call for help, emergency services will not be notified, and help will not arrive. Due to the unexpected and unplanned nature of an accident, it is also possible for the accident victim to simply be unaware of their location. Thus, even if a victim manages to call for help, they may not be able to convey accurate location information.

Wireless Enhanced 9-1-1 has been developed to improve upon the lack of location information associated with 9-1-1 calls from wireless handsets, however the technology has proven slow and costly to deploy. Residential and fixed VoIP (Voice over Internet Protocol) services have triggered similar problems as the Internet Protocol (“IP”) addresses associated with such devices may change frequently and offer no correlation to a specific geographic location.

### BRIEF DESCRIPTION OF THE DRAWINGS

The claims set forth the embodiments of the invention with particularity. Certain embodiments of the invention, together with its advantages, may be understood from the following detailed description taken in conjunction with the accompanying drawings. Embodiments of the invention are illustrated by way of example and not by way of limitation in the Figures of the accompanying drawings. It should be noted that references to “an,” “one,” “another,” “alternative,” or a “particular” embodiment in this disclosure are not necessarily referring to the same embodiment, although they may be, and such references mean at least one embodiment. Reference numerals are utilized herein to identify corresponding components of the Figures described below. Components corresponding to like reference numerals in multiple Figures represent like elements.

FIG. 1 illustrates a system at a service provider to receive a data communication from a remote terminal, send information to a call center pertaining to the remote terminal, correlate an incoming voice communication from the call center, responsive to the data communication, with the originating remote terminal, and forward the voice communication to the remote terminal, according to one embodiment of the invention.

FIG. 2 illustrates several remote terminals to monitor events, or create event codes, or both, and initiate a data communication to be received at a service provider where the data communication is routed to one of several call centers, the service provider then correlates an incoming voice communication from a call center responsive to the data communication and routes the voice communication back to the corresponding remote terminal according to a particular embodiment.

FIG. 3 illustrates an alternative view of a system having a remote terminal to encode telemetric data into a data communication for transmission to the service provider. The service provider sends a message to a call center where additional relevant information is associated with the data communication and represented at an operator station based on information sent with the data communication according to another embodiment.

FIG. 4 illustrates a flowchart depicting various steps, some optional, of a method at a service provider for receiving a data communication from a remote terminal, soliciting a call center to initiate a voice communication responsive to the data communication, receiving the voice communication from the call center, and forwarding the voice communication to the remote terminal that originated the data communication in accordance with an embodiment of the invention.

### DETAILED DESCRIPTION

The system, and methods described herein are capable of receiving data communications from a remote device, correlating the data communications with additional information pertaining to the remote device or its users, receiving a voice communication from a call center that is responsive to the data communication and forwarding the voice communication to the remote terminal.

One scenario illustrating such a system is that of a customer driving a vehicle fitted with a telephonically enabled remote terminal device. The customer may subscribe to a service that provides vehicle monitoring, concierge services, navigation services, emergency assistance services, and vehicle theft recovery services through the use of technology and trained customer service operators. Various events may trigger a data communication event, such as an accident or a state change of a monitored sensor. Depending on the type of event, a service provider may desire to route the data communication to one of many call centers or to a sub-class of customer service operators that are specifically trained to handle a given type of data communication event.

In one embodiment, a customer may suffer a serious automobile accident and not be able to manually trigger a phone call via the automobile's telephonic communication system. The vehicle may have an onboard computer connected with several electronic monitoring devices including a global positioning system (“GPS”) sensor, an accelerometer, a G-force detector, an airbag deployment detector, and a gyroscopic vehicle orientation sensor. Through the sensors, the onboard computer determines that an accident has occurred, and automatically triggers a data communication event to the service provider requesting emergency assistance. Without the manual intervention of the customer, the vehicle's onboard computer encodes an event code indicating a car accident, and a remote terminal identifier (“remoteID”) uniquely identifying the vehicle's remote terminal device into a data communication and transmits the data communication wirelessly to the service provider.

The telephonically enabled remote terminal and vehicle are communicably connected with the service provider via a local wireless carrier that transmits the data communication to the service provider in Short Message Service (“SMS”) format.

Upon receipt of the data communication, the service provider extracts the remoteID and uses it to retrieve additional information related to the remote terminal, such as an associated user. The service provider then selects a call center to service and respond to the data communication. The service provider may additionally use the event code, indicating a car accident in this example, to narrow a list of available call centers, or it may use other information sent by the remote terminal such as GPS coordinates.

The service provider sends a message to the selected call center via an Internet connection indicating the remoteID for the remote terminal so that the call center may also retrieve additional information associated with the remote terminal if necessary. The call center analyzes the message and assigns an operator station based on the contents of the message, including the event code indicating a car accident. The call center then prepares to originate an outgoing voice communication (e.g. a telephone call) to the remote terminal to offer assistance and may also send information to a dispatcher associated with emergency services providers (e.g. police, fire fighters, or medical assistance) based on the event code or other information received from the service provider. In an alternative embodiment, either the service provider or the call center may route available information, such as location, event code, user identity, and so forth, directly to an emergency services provider.

The call center then initiates the voice communication to the remote terminal responsive to the data communication placing the call center in voice contact with anyone within audible range of the remote terminal, in this case the customer who suffered a car accident. In this embodiment, the voice communication is routed to the service provider based on a telephone number dialed, correlated with the remote terminal at the service provider, and then forwarded to the remote terminal via the local wireless carrier.

In some embodiments, the remote terminal may not have a telephone number allocated to it that can be dialed (e.g. addressed or routed) via a Public Switched Telephone Network (“PSTN”), for example, a North American Numbering Plan (“NANP”) compatible telephone number. In these embodiments, the call center requests a telephone number from the service provider and the service provider returns a Temporary Local Directory Number (“TLDN”) that the call center may use to dial the remote terminal. In other embodiments, the service provider sends a TLDN initially with the message including the remoteID. Other variations of these embodiments are described below, such as using the remoteID to route the voice communication to the remote terminal once received by the service provider, or using a NANP compatible telephone number to route voice communications directly to the remote terminal over the PSTN by passing the service provider.

Once the call center is in voice contact with the remote terminal, the call center can render assistance to the customer. For instance, if the customer indicates that there was a car accident, but it was not severe, the call center can relay this information to emergency services who can then prioritize the need accordingly. Similarly, once in voice contact via the remote terminal, if there is no response or if the customer indicates a severe accident, the call center can summon medical attention on a prioritized basis. In some embodiments, data communications indicating a car accident or similar calamity can be routed directly to the emergency services call center, bypassing a default call center.

In some embodiments, prioritization can be made based on telemetric data included with the initial data communication from the remote terminal, such as information collected from connected sensors indicating speed, deceleration rates, vehicle orientation, and so forth. Alternatively, particulate counters and temperature sensors may be used to indicate and thus classify the intensity of a fire providing helpful information to emergency services providers.

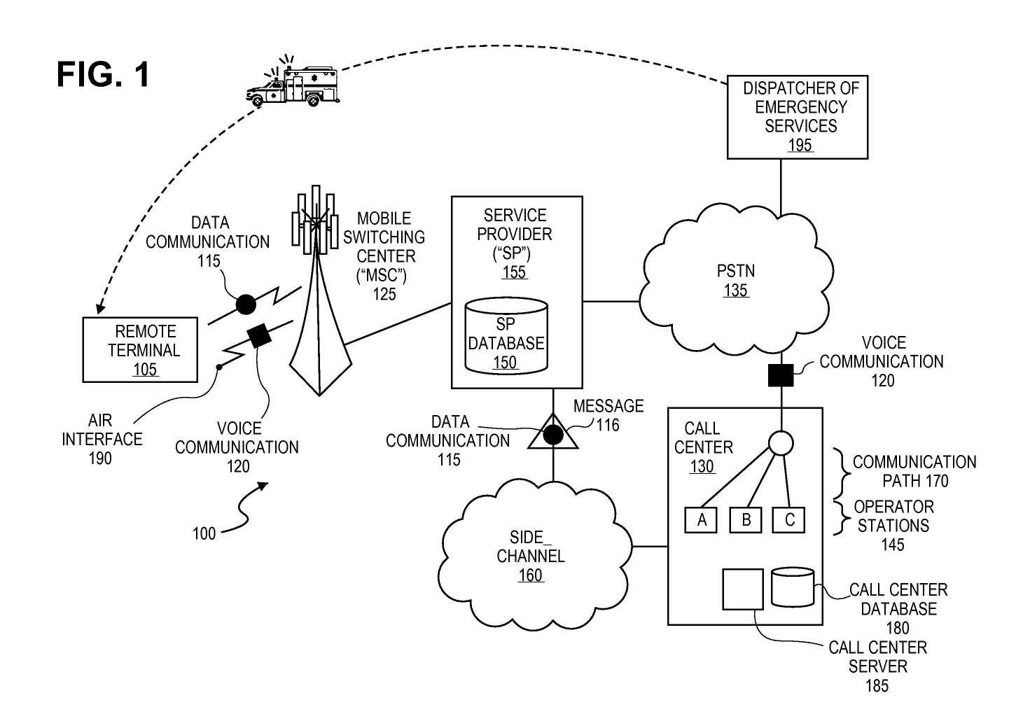

Refer now to FIG. 1 illustrating system 100 at service provider 155 to receive data communications 115 from remote terminal 105, send information (e.g. message 116) to call center 130 pertaining to remote terminal 105, correlate incoming voice communication 120 from call center 130 with remote terminal 105, and forward voice communication 120 to remote terminal 105 in response to data communication 115, according to one embodiment of the invention.

Service provider (“SP”) 155 is communicably connected with remote terminal 105 via Mobile Switching Center (“MSC”) 125. Data communication 115 and voice communication 120 are transmitted between remote terminal 105 and service provider 155 via MSC 125 over air interface 190. Public Switched Telephone Network (“PSTN”) 135 transmits voice communication 120 between SP 155 and call center 130 and further communicably connects dispatcher of emergency services (“dispatcher”) 195 with call center 130. Side channel 160 transmits message 116 and data communication 115 between SP 155 and call center 130. Call center 130 includes operator stations 145A, 145B, and 145C connected with PSTN 135 via communication path 170. Call center 130 further includes call center database 180. SP 155 includes SP database 150. SP database 150 and call center database 180 are communicably connected with each other via side channel 160.

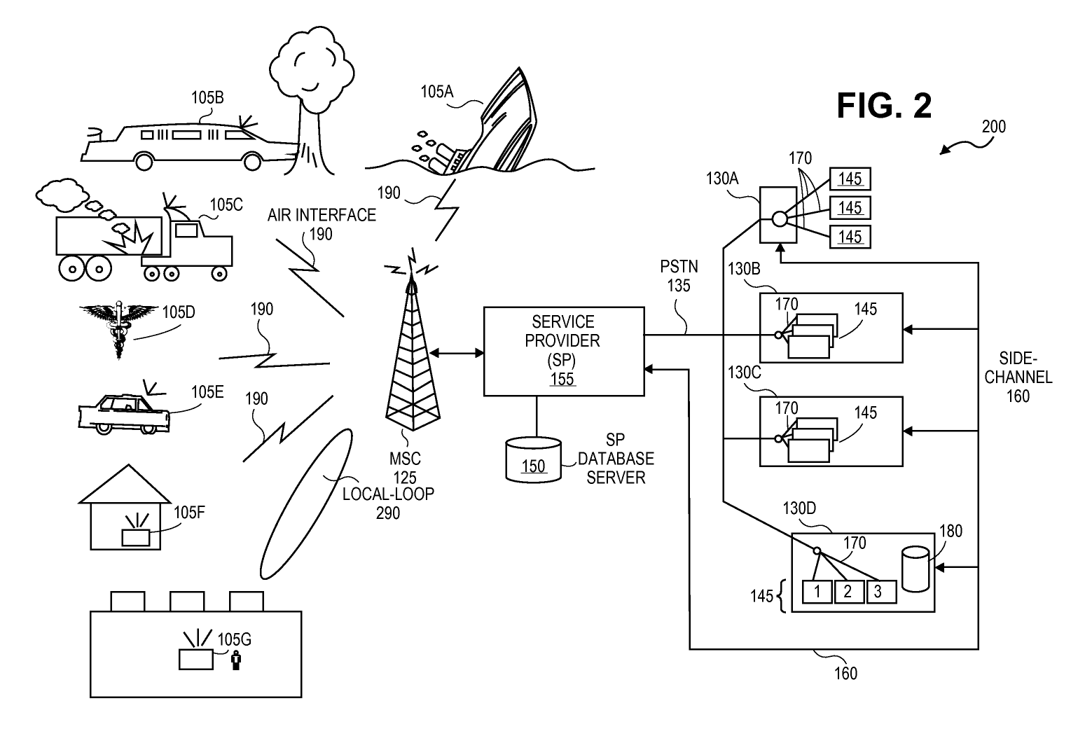

Remote terminal 105 can transmit data communication 115 to MSC 125 and receive voice communication 120 from MSC 125 via wireless communication mediums such as air interface 190 or wired communication mediums such as local loop 290 of FIG. 2. The communication standards used to transmit voice communication 120 may be of any wired or wireless voice transmission protocol including CDMA (code division multiple access) signals, GSM (Global System for Mobile Communications) signals, AMPS (Advanced Mobile Phone System) signals, TDMA (Time division multiple access) signals, satellite signals, or land-line telephone technology using twisted-pair, coax, or fiber optic mediums.

Voice communication 120 can be audible sounds, tones, or speech. In one embodiment, voice communication 120 is an analog signal representing spoken communication originating from operator station 145 at call center 130. In this embodiment, an operator's voice and other sounds from the surrounding environment are transmitted from operator station 145 to remote terminal 105 as voice communication 120. In another embodiment, voice communication 120 is a digital signal.

Mobile Switching Center (“MSC”) 125 is capable of receiving data communications 115 from remote terminal 105 and transmitting it to SP 155. In one embodiment MSC 125 is a circuit switch on PSTN 135. In another embodiment, MSC 125 is a wireless antenna enabled to receive data communications 115 from cellular telephones and other wireless devices compatible with CDMA, GSM, AMPS, or TDMA wireless communication protocols and further enabled to communicate with the PSTN 135. In yet another embodiment, MSC 125 is a communications satellite (“comsat”) receiver that transmits data communications 115 and voice communications 120 between remote terminal 105 and SP 155, or PSTN 135, or both. MSCs 125 are sometimes referred to as “central offices,” “exchanges,” or “branches,” wireless or local “carriers,” a “telephone exchanges,” a “carrier switch,” a “cell tower,” or some combination, but in essence, is the interface between communication devices, such as remote terminal 105 and other devices available via public switched telephone network 135, such as SP 155 and call center 130.

MSC 125 can send an acknowledgement message to remote terminal 105 confirming receipt of data communication 115. Alternatively, SP 155 can send the acknowledgement message, or both MSC 125 and SP 155 can send an acknowledgement message to remote terminal 105. Similarly, SP 155 may send an acknowledgement message to MSC 125 confirming receipt of data communication 115.

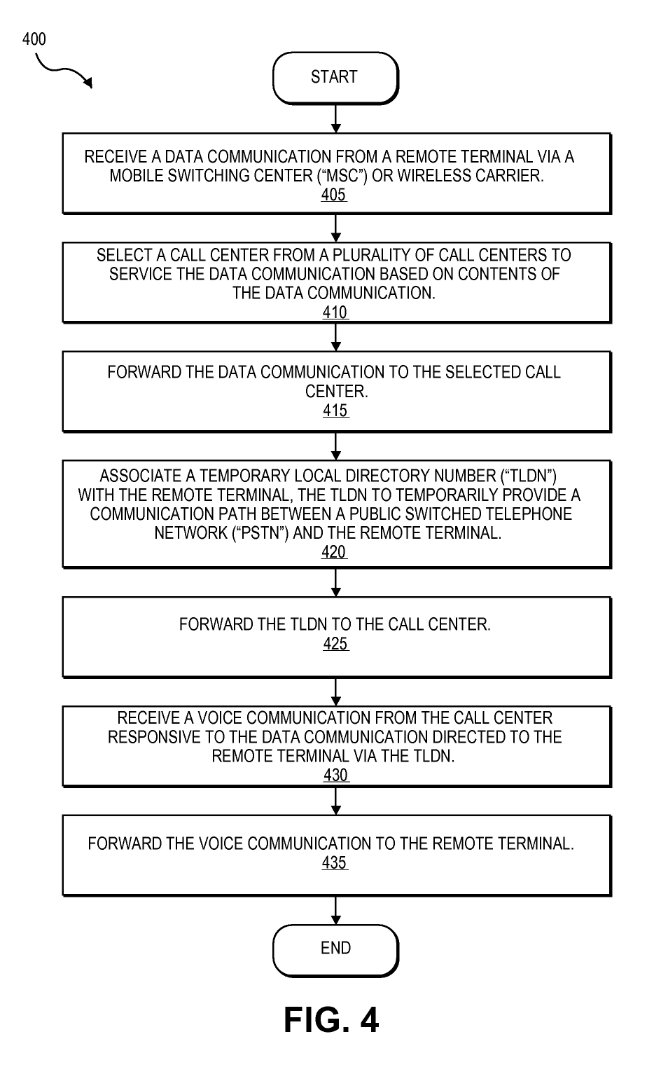

SP 155 receives data communication 115 from remote terminal 105 via MSC 125 (FIG. 4, block 405). SP 155 selects one of many call centers 130 to receive data communication 115 or message 116 containing all or part of data communication 115 based at least in part on the contents of data communication 115 (FIG. 4, block 410). SP 155 then sends message 116 or data communication 115 to the selected call center for servicing (FIG. 4, block 415).

SP 155 can be integrated with MSC 125 into one machine or location, or operate separately from it as shown. In some embodiments, multiple service providers (“SPs”) 155 are used in conjunction with one or more MSCs 125. In other embodiments, SPs 155 are paired with an equal number of MSCs 125. SP 155 can be an application executing on a generic hardware platform, or it can be dedicated hardware and firmware, or some combination of these. SP 155 provides sophisticated routing of data communication 115 through the use of pattern matching, regular expression, positional character pattern matching, or other analysis on information provided by remote terminal 105 and MSC 125 to describe data communication 115 in the form of telemetry data.

Data communication 115 (e.g. telemetry data) includes such things as serial numbers of the originating remote terminal 105, location of the MSC 125 receiving data communication 115, or event codes indicating the reason for data communication 115. Data communication 115 originates at remote terminal 105 and is transmitted to MSC 125 via wired or wireless mediums. The wired or wireless messaging protocol or standard used may be any of well known protocols known in the art, such as Short Message Delivery Point-to-Point (SMDPP), Short Message Peer to Peer (SMPP), Microburst™ technology, ANSI-41, GSM Mobile Application Part (MAP) signals, Short Message Service (SMS), ANSI 2000 compatible Code Division Multiple Access (CDMA) messaging protocols, General Packet Radio Service (GPRS) protocol, Universal Mobile Telecommunications System (UMTS) protocol, High-Speed Downlink Packet Access (HSDPA), and any other means of transmission, including encoding the data communication 115 into fields of an overhead control channel signal between a transmitter and a receiver. MSC 125 may encode additional information known only to it into telemetry data 115 before forwarding telemetry data 115 on to SP 155.

SP 155 can communicate with multiple incompatible telephony networks within PSTN 135, acting as a translator or a communications gateway. SP 155 can intercept, capture, hold, or delay voice communication 120 from call center 130 while it determines which remote terminal 105 is to receive voice communication 120. This delay is normally no more than a few seconds and can include time-to-live request functionality that triggers fall-back logic should SP 155 be unable to route voice communication 120 to an appropriate remote terminal 105. For example, in one embodiment, voice communication 120 is received at SP 155 and SP 155 drops or terminates voice communication 120 without routing it to any remote terminal 105 because it is determined the voice communication did not originate from an authorized call center. In another embodiment, SP 155 receives voice communication 120 directed to a telephone number no longer associated with any remote terminal (e.g. 105), and drops voice communication 120 based on fall-back logic rather than routing the call to remote terminal 105.

In an alternative embodiment, SP 155 employs time-to-live logic to enforce a time-limit in which an operator station (145 A-C) or call center 130 must respond to data communication 115 forwarded by SP 155. For example, in one embodiment, SP 155 forwards data communication 115 to call center 130 and receives incoming voice communication 120 from call center 130 within a pre-determined time limit (e.g. 5, 10, or 60 seconds, depending on criteria such as criticality). In this embodiment, SP 155 does not engage a back-up call center as responsive voice communication 120 has been received within a time period deemed acceptable. In yet another embodiment, call center 130 fails to respond by initiating voice communication 120 to remote terminal 105 within the pre-determined time-limit and SP 155 therefore sends data communication 115 to a back-up call center, and awaits responsive voice communication 120 initiated from the back-up call center to remote terminal 105.

MSC 125 can assign a Temporary Local Directory Number (“TLDN”) to remote terminal 105 if it is “roaming” on a foreign network, uses an address or phone number incompatible with PSTN 135, such as a Mobile Identification Number (MIN) or an International Mobile Subscriber Identity (IMSI), that cannot be addressed or dialed via PSTN 135 (FIG. 4, block 420). Similarly, MSC 125 can assign a TLDN to remote terminal 105 if it does not have a PSTN 135 compatible telephone number allocated to it. The TLDN allows call center 130 to contact remote terminal 105 via PSTN 135 while the TLDN is associated with remote terminal 105.

Phone numbers that are compatible with PSTN 135 in North America are based on the North American Numbering Plan (“NANP”). The NANP organization specifies special syntax and rules for NANP compliant telephone numbers and those rules must be adhered to if a telephone call is routed via an NANP compliant PSTN 135, such as the one used in the United States and Canada. Exemplary NANP rules state that compatible phone numbers have an area code of three digits, an exchange code of three digits, and a station code of four digits. Other NANP rules specify that the first digit of an area code cannot be “1” and the second digit cannot be “9.” There are also special numbers such as toll free numbers (e.g. 888-123-5678), emergency numbers (e.g. “9-1-1”), and other abbreviated numbers (e.g. “4-1-1” for directory services and “0” for an operator).

Voice communication 120 originating from call center 130 may be routed through SP 155 and MSC 125 to remote terminal 105 or can be routed around SP 155 to MSC 125 and remote terminal 105. For example, in one embodiment, voice communication 120 originates at call center 130 and is routed by PSTN 135 to SP 155 based on a NANP compatible telephone number provided to call center 130 by SP 155. In this embodiment, SP 155 assigns or temporarily associates the telephone number with remote terminal 155 and sends the telephone number to call center 130. When SP 155 receives voice communication 120 from call center 130 using the telephone number sent, SP 155 routes voice communication 120 to remote terminal via MSC 125.

In one embodiment, SP 155 receives voice communication 120 from call center 130 destined for remote terminal 105 using a NANP compatible telephone number via PSTN 135. In an alternative embodiment, SP 155 receives voice communication 120 from call center 130 destined for remote terminal 105 using a non-NANP compatible telephone number via a Private Branch eXchange (“PBX”) system used to route internal “extensions” between call center 130 and SP 155 over PSTN 135. For example, in this embodiment, call center 130 sends voice communication 120 to SP 155 via a PBX using an internal extension (e.g. x5678 or x1234).

In a particular embodiment, SP 155 sends call center 130 a NANP compatible telephone number for use in routing voice communication 120 to remote terminal 105. Call center 130 initiates voice communication 120 with remote terminal 105 via the telephone number provided, and PSTN 135 routes voice communication 120 directly to MSC 125, thus bypassing SP 155. MSC 125 routes voice communication 120 to remote terminal 105 based on the NANP compatible telephone number without further intervention from SP 155.

In an alternative embodiment, call center 130 initiates voice communication 120 with remote terminal 105 routed via a MIN or IMSI provided by remote terminal 105. MIN and IMSI numbers are not NANP compliant and are thus incompatible with PSTN 135. In such an embodiment, call center 130 routes voice communication 120 to SP 155 via PSTN using a PSTN 135 compatible telephone number. SP 155, upon receiving voice communication 120 correlates the voice communication with originating remote terminal 105 and forwards voice communication 120 to remote terminal 105 via MSC 125 using the MIN or IMSI specified by call center 130 to route the call. In this embodiment, known data such as the MIN or IMSI or a pre-determined incoming telephone number from call center 130 can be used by SP 155 to correlate incoming voice communication 120 with originating remote terminal 105.

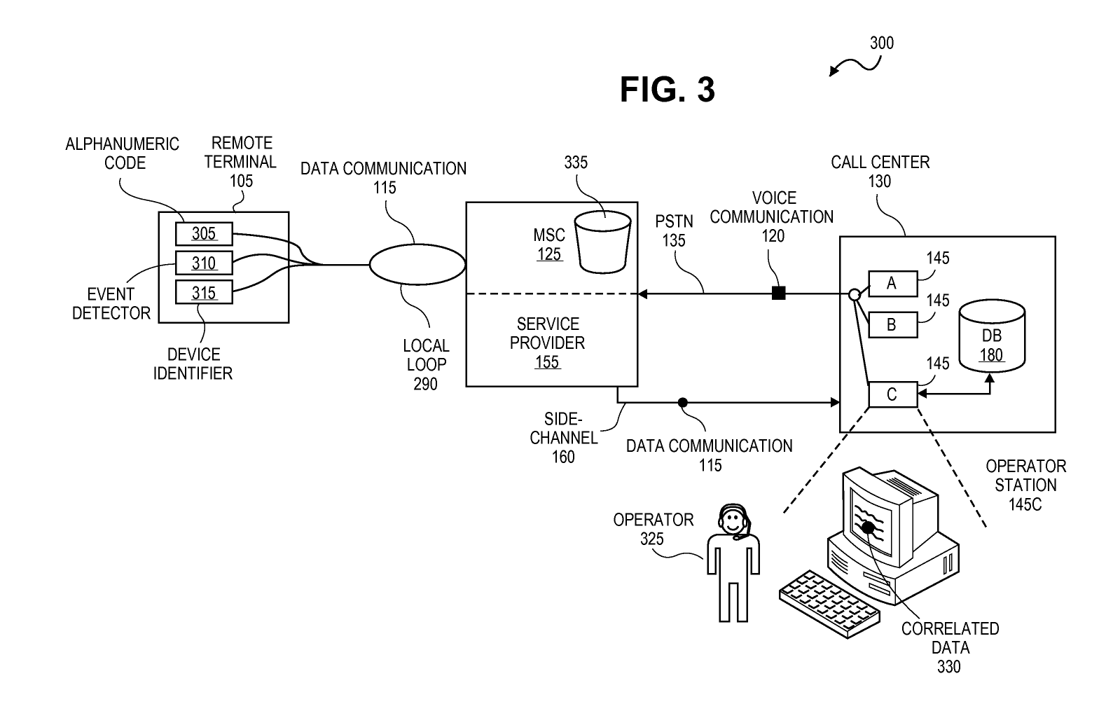

MSC 125 may keep track of which telephone numbers are assigned to which remote terminals (e.g. 105) using, for example, a database communicatively interfaced with MSC 125 (e.g., such as MSC database 335 of FIG. 3). In one embodiment, MSC 125 assigns a TLDN to remote terminal 105 and records the TLDN assignment in MSC database 335. MSC 125 sends the TLDN to SP 155, which in turn sends the TLDN to call center 130 (FIG. 4, block 425), which uses the TLDN to route voice communication 120 to remote terminal 105 via SP 155 (FIG. 4, block 430). In an alternative embodiment, SP 155 may query MSC 125 for the TLDN associated with remote terminal 105.

SP 155 receives voice communication 120, determines the telephone number used to route voice communication 120 (e.g. the TLDN used by call center 130), and determines which remote terminal 105 should receive voice communication 120 based on information previously stored in SP database 150, such as an association between the TLDN and remote terminal 105.

SP 155 can receive voice communications (e.g. 120) from call center 130, associate the voice communications with one of many remote terminals (e.g. 105), and forward the voice communications to the appropriate remote terminal (FIG. 4, block 435). In one embodiment, SP 155 receives voice communication 120 from call center 130 via PSTN 135 destined for remote terminal 105. In this embodiment, SP 155 forwards voice communication 120 to remote terminal 105 via MSC 125 and provides a new telephone number for routing the voice communication. In an alternative embodiment, SP 155 uses the telephone number specified by call center 130 where voice communication 120 originated to route the voice communication to remote terminal 105 via MSC 125. In a particular embodiment, SP 155 forwards voice communication 120 to remote terminal 105 using a IMSI, ESN, or MIN, recognizable to MSC 125 for routing voice communications (e.g. 120) to any remote terminals (e.g. 105) connected with MSC 125. In yet another embodiment, SP 155 forwards voice communication 120 to remote terminal 105 via a telephone number that is incompatible with PSTN 135 or NANP conventions, or both, but understood by MSC 125 for use in routing voice communications (e.g. 120).

In one embodiment, SP 155 intercepts voice communication 120 from call center 130 via PSTN 135 and replaces the original routing information, such as the destination telephone number, with routing information pulled from database 150, then forwards voice communication 120 to remote terminal 105 via MSC 125. In another embodiment MSC 125 and SP 155 are co-located and function as a single unit. The MSC/SP unit receives voice communication 120 destined for remote terminal 105 as specified by a destination telephone number, extracts the destination telephone number from voice communication 120, queries database 150 for a match using the destination telephone number as a search parameter, and modifies the destination telephone number with a destination address associated with the matched destination telephone number from database 150.

SP database server 150 can be a server/database combination machine, multiple machines, or software to realize the functions of a database repository and a server capable of executing instructions and logic. SP database server 150 may be referred to as a server, as a database, or as a database server. SP database server 150 can store a mapping of telephone numbers associated with call centers 130 to Internet addresses, such as IP addresses or uniform resource locator (“URL”) addresses for servers (e.g. call center server 185) and databases (e.g. call center database 180) associated with call centers 130. SP database server 150 can also store a mapping of telephone number ranges temporarily associated with remote terminals (e.g. 105) and serviced by a particular call center (e.g. 130), in addition to mapping internet addresses, event codes, and other information associated with a call center (e.g. 130) or a remote terminal (e.g. 105).

SP 155 can perform different actions on incoming data communications 115. For example, in one embodiment, SP 155 sends message 116 to multiple call centers 130 soliciting information regarding operator station 145 queue times, and then sends message 116 pertaining to data communication 115 requesting the call center with the most favorable queue time 130 to respond to remote terminal 105 by initiating voice communication 120. In one embodiment, operator station 145(A) has a queue time of zero (0) and is selected by call center 130 to respond to remote terminal 105. In yet another embodiment, SP 155 sends message 116 to multiple call centers 130 and selects which call center 130 to forward message 116 pertaining to data communication 115 to based on multiple responses received in a finite amount of time from the call centers (e.g. 130), or from other information provided by the call centers in response to message 116, such as a call center 130 priority code, or a call center utilization percentage.

SP 155 can route communication 110 to different call centers based on information encoded in data communication 115. For example, in one embodiment, all data communications 115 having an event code indicating an emergency are forwarded to call center 130 operated by an emergency services provider, such as a fire department, a police station, an ambulatory service, or the United States Coast Guard. SP 155 can forward data communication 115 to a call center 130 based upon a location provided by MSC 125. For example, in one such embodiment, SP 155 maintains a list of all police station call centers 130 in the United States, including their respective service areas. SP 155 receives data communication 115 and selects a police station call center 130 to respond to data communication 115 based on the physical proximity of the police station call center 130 to the MSC 125 location.

SP 155 receives voice communication 120 from call centers 130, but is not the destination for voice communication 120, and must therefore forward the voice communication 120 a remote terminal (e.g. 105) associated with a previously received data communication 115. SP 155 may however be the destination for information sent from call center 130. For example, in one embodiment, call center 130 sends a message to SP 155 requesting a TLDN for remote terminal 105. In another embodiment call center 130 sends an acknowledgement to SP 155 responsive to message 116 sent from SP 155 to call center 130.

Service provider 155 can send messages to call center 130 and receive responses from call center 130 via side-channel 160. Side-channel 160 can be a data connection between the call center 130 and the SP 155 provided by an internet service provider (“ISP”), a digital network connection on a local area network (“LAN”), a connection on a secured intranet, a tunneling virtual private connection (“VPN”), an encrypted network connection over a public data network, such as a secure sockets layer (“SSL”) connection, or any other connection enabling the SP 155 to send and receive data to and from call center 130.

PSTN 135 may be comprised of many telephony networks each operated by a telecommunications company such as the traditional land-line “baby-bells,” modern cellular providers, or more recently, non-traditional carriers such as Comcast Cable who now offers land-line telephony services. Each telephony network within PSTN 135 is capable of transmitting voice communication 120 between networks, but is at least logically separate from side-channel 160, and often physically distinct from side-channel 160. In one embodiment, PSTN 135 links traditional land-line telephones with multiple telephone carriers, and further links cellular telephone carriers to traditional land-line phones and remote terminals 105 through the use of MSCs 125 and telecommunication gateways. In a particular embodiment, PSTN 135 is a telephone network of a foreign country having a connection with PSTN 135, capable of transmitting voice communication 120 transmissions between SP 155, MSC 125, call center 130, remote terminal 105, or some combination thereof.

Call center 130 can make use of database 180 or other servers accessible from call center 130. When call center 130 receives message 116 from SP 155 via side-channel 160, call center 130 may use database 180 to receive and respond to the message. In one embodiment database 180 receives a message from SP 155 requesting call center 130 to respond to data communication 115 received at SP 155. Database 180 tracks the availability of operator stations 145 at call center 130 and assigns available operator station 145(A) to initiate voice communication 120 to remote terminal 105. Database 180 sends an acknowledgement to SP 155 indicating that voice communication 120 is being initiated, or requests a TLDN for remote terminal 105 with which to initiate voice communication 120. Operator station 145(A) at call center 130 then initiates voice communication 120 (e.g. makes a phone call) via PSTN 135 specifying a route based on a TLDN, extension, or phone number provided by SP 155.

Dispatcher of Emergency Services (“dispatcher”) 195 may be contacted based on the contents of data communication 115 or based on additional information received as a result of initiating voice communication 120 with remote terminal 105. Dispatcher 195 may be an emergency services first responder, such as a first department, police department, or ambulatory service, or dispatcher 195 may be a special call center that routes emergency calls to the appropriate destination. For example, in one embodiment, dispatcher 195 is a Public Safety Answering Point (“PSAP”). In another embodiment, dispatcher 195 is a police department located within a pre-determined distance (e.g. 10 miles) of MSC 125. In an alternative embodiment, data communication 115 is a distress signal from an airplane and dispatcher 195 is a control tower at a nearby airport. In yet another embodiment, dispatcher 195 is a Coast Guard ship or facility.

An operator at call center 130 may contact dispatcher 195 via PSTN 135, or send a digital communication to dispatcher 195. Similarly, SP 155 may send message 116 to dispatcher 195 based on an event code embedded in data communication 115. For example, in one embodiment, call center 130 contacts dispatcher 195 and requests that medical assistance be sent to a location associated with remote terminal 105. In another embodiment, SP 155 receives data communication 115 indicating a fire, and sends message 116 to a fire department (e.g. dispatcher of emergency services 195) with information including the street address of remote terminal 105, and sends message 116 to call center 130 requesting call center 130 initiate voice communication 120 with remote terminal 105.

Turning now to FIG. 2 depicting several remote terminals 105(A-G), each capable of monitoring events and initiating a data communication 115 events to be received at SP 155 according to an embodiment of the invention. Remote terminals 105(A-G) each transmit data communications 115 to MSC 125 wireless air interface 190 or hard-wire local-loop 290. MSC 125 is communicatively connected with call centers 130(A-D) through side-channel 160 and is further communicatively connected with call centers 130(A-D) via a separate PSTN 135 interface. PSTN 135 links MSC 125 and SP 155 with communication paths 170 leading to each operator station 145 located at call centers 130(A-D). SP 155 is connected between MSC 125 and call centers 130(A-D) via side-channel 160. SP 155 has access to both database 150 and database 180 accessible via call center 130D.

Remote terminals 105(A-G) can be application specific and designed to operate uniquely in a specific environment. SP 155 and call centers 130(A-D) can customize routing of data communications 115 and voice communications 120 between remote terminals 150(A-G), various call centers 130(A-D), and operator stations 145 based on information within data communication 115 originating from remote terminals 105(A-G). Remote terminals 105(A-G) may further contain or be connected with sensors, event detectors, or computers that provide additional information to remote terminals 105(A-G) for transmission with data communication 115. Remote terminals 105(A-G) may encode additional information from the sensors, event detectors, or computers into data communication 115.

For example, in one embodiment remote terminal 105A is a telephonically enabled apparatus for use in marine or aquatic applications. When SP 155 captures or receives data communication 115 originating from remote terminal 105A, SP 155 directs a communication to a United States Coast Guard call center (e.g. 130A) based on information contained within data communication 115 and based further on information stored in SP database 150. In another embodiment, remote terminal 105B is installed into an ultra-luxury automobile, such as a ROLLS-ROYCE™, BMW™, or a MAYBACH MERCEDES-BENZ™. Upon intercepting data communication 115 remote terminal 105B, SP 155 determines the specific make and model of the vehicle based on a vehicle identification number (“VIN”) embedded in data communication 115, looks up which call center 130 services that particular make and model of vehicle from SP database 150, and forwards message 116 to call center 130D which exclusively handles high-value clientele driving such ultra-luxury automobiles.

Similarly, SP 155 can determine based on a unique device serial number associated with remote terminal 105C that data communication 115 is coming from a tractor-trailer or semi-truck and route incoming data communication 115 accordingly. Service provider 155 can likewise analyze data communication 115 originating from a wireless emergency request device (e.g. 105D), an onboard vehicle communication remote terminal 105E, a security alarm system telephone device 105F, a heating ventilation and air conditioning (“HVAC”) monitoring station 105G, and from a wide array of other wired or wireless remote terminals 105(A-G).

Service provider 155 determines which of many call centers 130(A-D) are to respond to data communication 115 via voice communication 120 based on predetermined information stored in database 150, information encoded in telemetry data 115, or information provided by MSC 125. Similarly, each call center 130(A-D) can determine which operator station 145 among a plurality of operator stations 145 will be assigned to initiate voice communication 120 to the requesting remote terminal.

Operator stations 145 can be located inside of call center 130, or may be physically separate from call center 130, but connected with it. For example, in one embodiment, operator stations 145 are located inside of employees' homes and connection path 170 connects each operator station 145 with call center 130, as shown in FIG. 2, operator station 130A. In another embodiment, operator stations 145 are located inside of a call center 130 and each operator station 145 is connected via connection path 170 through a local PBX (private branch exchange) terminal. In yet another embodiment, operator stations 145 are located in a foreign country but connected with a dispatch office call center 130 located in the United States via communication paths 170 and data communications 115 are transmitted via side channel 160, while voice communications 120 are transmitted via PSTN 135.

Refer now to FIG. 3 illustrating an alternative view of a system 300 having remote terminal 105 to encode information into data communication 115 for transmission to MSC 125 and SP 155 via local loop 290. SP 155 sends data communication 115 to call center 130 where additional relevant information is associated with data communication 115 and presented to an operator station 145. Remote terminal 105 contains alphanumeric code 305, event detector 310, and device identifier 315. Remote terminal 105 encodes information from the alphanumeric code 305, event detector 310, and device identifier 315 into data communication 115 for transmission to SP 155 via local loop 290 and MSC 125. Additional relevant information is associated with data communication 115 at call center 130 and represented as correlated data 330 at operator station 145C based on information sent with data communication 115 or message 116 according to a particular embodiment. Call center 130 initiates an outgoing voice communication 120 to SP 155 via PSTN 135. SP 155 receives voice communication 120 with remote terminal 105, correlates voice communication 120 with remote terminal 105, and forwards voice communication to remote terminal 105 via MSC 125 and local loop 290 putting operator 325 at call center 130 in voice contact with remote terminal 105.

Remote terminal 105 can encode information accessible by remote terminal 105 into data communication 115 for later use by the SP 155 in correlating and returning voice communication 120 from call center 130 responsive to data communication 115. Information encoded into data communication 115 can be forwarded to call center 130 by SP 155 in the form of message 116 over side-channel 160 containing information from data communication 115, or data communication 115 can be forwarded itself to call center 130 via side channel 160. When call center 130 receives message 116, it can assign one operator station 145 (A-C) to service or respond to data communication 115 based on the contents of data communication 115. In some embodiments, SP 155 can forward data communication 115 directly to an operator station (A-C) at call center 130 based on contents of data communication 115 or other information associated with remote terminal 105 based on analysis of data communication 115 at SP 155.

Information that remote terminal 105 encodes into data communication 115 may come from a variety of sources. Alphanumeric code 305 for example, can be any sequence of numbers, symbols, or characters input into remote terminal 105. In one embodiment, alphanumeric code 305 is a toll free telephone number associated with a call center, such as a United States toll free telephone number beginning with a prefix of 800, 888, 866, etc. In another embodiment, alphanumeric code 305 is a unique code transmitted from remote terminal 105 to MSC 125 via data communication 115. In yet another embodiment, a short message entered into, or stored at remote terminal 105, such as “h-e-l-p,” or “S-O-S,” or “9-1-1” can be encoded by remote terminal 105 into data communication 115 and used by SP 155 to route data communication 115 to call center 130 based on the encoded characters, such as an emergency services provider. One call center 130 may wish to service data communications 115 with the string “f-o-o-d” encoded into the telemetry data, anticipating requests for restaurant concierge services.

Event detector 310 can be a sensing device internal to remote terminal 105 itself or an interface with another computer or device capable of capturing or generating information and providing the information to event detector 310 as input. For example, in one embodiment, event detector 310 is installed into a vehicle, such as remote terminal 105E of FIG. 2. In this embodiment, event detector 310 has an air pressure detector that determines the vehicle associated with remote terminal 105E has a flat tire. In an alternative embodiment, event detector 310 is connected with a global positioning system (“GPS”) sensor, an accelerometer, an airbag deployment detector, a gyroscopic vehicular orientation sensor, and a crash detection computer that inputs data from the sensors into event detector 310. In another embodiment event detector 310 is installed into a marine application, such as remote terminal 105A of FIG. 2, and comprises a yaw, pitch, and roll detector, a water pressure gauge, a salinity sensor, and a thermostat.

In yet another embodiment, event detector 310 comprises sensors to detect vehicle fuel efficiency, vehicular speed, and a vehicle odometer interface for use in a tractor-trailer such as remote terminal 105C of FIG. 2. In a particular embodiment, remote terminal 105F of FIG. 2 is used in a security system and event detector 310 comprises an alarm state sensor, multiple entry point sensors capable of detecting open and shut positions of doors and windows, a smoke detection sensor, a carbon monoxide sensor, a temperature sensor, and a humidity sensor. In an alternative embodiment, event detector 310 is installed into remote terminal 105G of FIG. 2 for use in heating ventilation and air conditioning (“HVAC”) monitoring and comprises sensors including a motor load sensor, an air particulates sensor, a temperature sensor, a humidity sensor, an air flow sensor, an interior air pressure sensor, and multiple HVAC unit operating state sensors. Sensor information encoded into data communication 115 can be used by SP 155, call center 130, or operator stations 145 for routing data communication 115 from remote terminal 105 to particular call centers 130 or operator stations 145, or both.

Device identifier 315 may be used to encode information stored on remote terminal 105 into telemetry data 115 for later use in uniquely identifying a particular remote terminal 105, determining the type of the remote terminal 105, or for associating correlated data 330 with a data communication 115 originating from remote terminal 105. In one embodiment, device identifier 315 comprises a MIN (mobile identification number) that remote terminal 105 encodes into telemetry data 115 for transmission with data communication 115. In another embodiment, device identifier 315 comprises an IMSI (International Mobile Subscriber Identity) number, or an ESN (Electronic Serial Number) for a mobile device. In a particular embodiment, device identifier 315 comprises a VIN (vehicle identification number) for an automobile. In yet another embodiment, device identifier 315 stores an addressable NANP compatible phone number for a land-line remote terminal 105, such as a telephone and hand-set, connected with PSTN 135 which call center 130 may use to route voice communication 120. In an alternative embodiment device identifier 315 comprises a MAC (medial access control) address number for devices comprising an Ethernet interface, or a device serial number that uniquely identifies an electronic remote terminal 105.

Device identifiers 315 are passed to call centers 130 via SP 155 over side channel 160. Call center 130 may use device identifier 315 or information supplied by device identifier 315 to retrieve correlated data 330 from SP database server 150, call center database 180, or from other data repositories. For example, in one embodiment, call center 130 receives device identifier 315 comprising a VIN and queries database 180 using the VIN to retrieve correlated data 330. In another embodiment, call center 130 receives device identifier 315 comprising an ESN and retrieves correlated data 330 based on the ESN.

Correlated data 330 can be any information capable of being stored in databases 150 and 180, data repository, or other storage medium where stored data is retrievable through use of information encoded into data communication 115 based on device identifier 315. For example, in one embodiment, correlated data 330 is customer account information. In another embodiment, correlated data 330 is a person's medical history, retrieved by call center 130 when SP 155 sends data communication 115 from medical alert remote terminal 105D. In a particular embodiment, correlated data 330 comprises the entertainment preferences associated with the user of remote terminal 105, including favorite restaurants, favorite foods, disliked foods, preferred spending range for dining, preferred aircraft seating, preferred sporting events, private memberships, and so on. In an alternative embodiment, correlated data 330 includes security passwords, authorized persons for a premises, emergency client contact numbers, and pre-arranged distress codes, all for use with data communication 115 related to a security remote terminal (e.g. 105F).

MSC 125 can encode information into data communication 115 when it interfaces between remote terminal 105 and SP 155. MSC 125 may encode a unique MSC identifier, a timestamp, an MSC location code, a data communication 115 priority code, or a remote terminal 105 location code describing the estimated location of remote terminal 105 based on triangulation estimates using data from MSC 125 and surrounding MSCs 125. In one embodiment, MSC 125 encodes a cell-tower ID and stored GPS coordinates for its location.

Call center 130 may prioritize the order in which it initiates outgoing voice communications 120 responsive to multiple incoming data communications 115 from remote terminals 105. In one embodiment, call center 130 sends an acknowledgement to SP 155 but delays initiating the outgoing voice communication 120 responsive to a corresponding data communication.

Call center 130 or SP 155 may assign operator stations 145 to accept and respond to incoming data communication 115 on a random basis, on a round-robin basis, or by other systematic or arbitrary means. Call center 130 however, can also use sophisticated selection techniques to assign operator stations 145 to initiate outgoing voice communication 120 to remote terminal 105 based on data communication 115 contents or other data associated with data communication 115.

Operator station 145 may be a computer and telephone in a call center, a headset and computer display in an ambulance, police car, or helicopter, or a hand-held radio and a portable electronic device on a marine vessel. When call center 130 assigns an operator station 145 to initiate voice communication 120 with remote terminal 105, it can transmit correlated data 330 to the assigned operator station 145 so that correlated data 330 is available when voice contact is made with remote terminal 105.

In some embodiments, call center 130 may request updated or additional telemetry data 115 from SP 155. The updated or additional telemetry data may be available from remote terminal 105, MSC 125, SP 155, or SP database server 150.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine, such as remote terminal 105 that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

Aspects of the processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. For example, an IMSI may be used instead a MIN depending upon which region or country that the remote terminal 105 is operating in. The specification and drawings are, accordingly, to be regarded in an illustrative rather than a restrictive sense.

Thus, disclosed is a system 100 and 300, method 400, and devices 200 for receiving data communications 115 from a plurality of remote terminals 105 via MSC 125, including device identifier 315 for remote terminal 105; selecting call center 130 to respond to each data communication 115; sending a message via side-channel 160 to call center 130 including at least a portion of data communication 115; receiving voice communication 120 from call center 130, responsive to message 116 or data communication 115 via PSTN 135; and routing voice communication 120 to remote terminal 105 associated with message 116 or data communication 115 via MSC 125.

1. A method at a service provider comprising:
receiving data communications from a plurality of remote terminals via a wireless carrier, each data communication including a remote terminal identifier (“remoteID”) corresponding to the originating remote terminal;
selecting a call center to respond to each data communication based at least in part on the remoteID included in the data communication;
sending a message via a side-channel to the call center selected, the message including the remoteID;
receiving a voice communication from the call center responsive to the message, the voice communication received via a Public Switched Telephone Network (“PSTN”); and
routing the voice communication to a remote terminal associated with the message via the wireless carrier.

2. The method of claim 1, wherein sending the message to the call center selected comprises:
associating a temporary telephone number with the remoteID; and
sending the message to the call center, wherein the message includes the remoteID and the temporary telephone number.

3. The method of claim 2, wherein receiving the voice communication from the call center comprises:
receiving a phone call from the call center, the phone call addressed to the temporary phone number; and
associating the phone call with the message based on the temporary phone number used to address the phone call.

4. The method of claim 3, wherein routing the voice communication to the remote terminal associated with the message comprises:
forwarding the phone call to the remote terminal using the temporary phone number, wherein the temporary phone number comprises a North American Number Plan (“NANP”) compatible telephone number.

5. The method of claim 3, wherein routing the voice communication to the remote terminal associated with the message comprises:
sending the phone call to the remote terminal using the remoteID to route the phone call via the wireless carrier when the temporary phone number is not compatible with a North American Numbering Plan (“NANP”) convention.

6. The method of claim 1, wherein the remote terminal does not have a North American Numbering Plan (“NANP”) compatible telephone number allocated to it.

7. The method of claim 1, further comprising:
receiving a request from the call center via the side-channel, the request soliciting a telephone number to use in routing the voice communication to the remote terminal; and
sending a Temporary Local Directory Number (“TLDN”) to the call center responsive to the request, the TLDN to communicably link the PSTN to the remote terminal via the wireless carrier.

8. The method of claim 7, further comprising:
screening the voice communication against a list of authorized call centers; and
terminating the voice communication when the source is not in the list of authorized call centers.

9. The method of claim 1, wherein the wireless carrier transmits each data communication in a Short Message Service (“SMS”) compatible format.

10. The method of claim 1, wherein each data communication further comprises an event code indicating an event associated with the remote terminal, wherein the event code is selected from a group of event codes comprising a car accident, a vehicle diagnostics error, a security system alarm, an HVAC (heating, ventilation, and air-conditioning) system malfunction, a distress signal, and a wearable medical assistance device event; and wherein
the remoteID uniquely identifies the remote terminal to the service provider via one or more of a Mobile Identification Number (“MIN”), an International Mobile Subscriber Identity (“IMSI”) number, an Electronic Serial Number (“ESN”), a Media Access Control (“MAC”) number and a Vehicle Identification Number (“VIN”) of a vehicle associated with the remote terminal, and wherein.

11. The method of claim 10, wherein selecting the call center to respond to the data communication comprises:
selecting the call center based on the remoteID and further based on the event code.

12. The method of claim 11, wherein selecting the call center based on the remoteID and further based on the event code comprises:
selecting the call center from a plurality of call centers based on a remote terminal to call center map identifying which of the plurality of call centers is predetermined to service data communications originating from the remote terminal based on the remoteID and the event code.

13. The method of claim 1, wherein the side-channel comprises an Internet connection established through an Internet Service Provider (“ISP”), and wherein the PSTN connection comprises a telecommunications circuit established through a telecommunications carrier.

14. The method of claim 1, wherein the remote terminal comprises a telephonic device selected from the group consisting of: a wireless handset, a telephonic vehicle, a telephonic security system, a telephonic HVAC (heating, ventilation, and air-conditioning) system, an electronic monitoring device, an electronic tracking device, a temperature monitoring device, a fire detection device, a moisture detection device, a location detection device, a television set-top box, a satellite signal receiver, a wearable medical alert telephonic device, a telephonically enabled tractor-trailer, or a combination thereof.

15. The method of claim 1, wherein the call center comprises a plurality of operators and a plurality of operator stations, wherein each operator station comprises a computer, a computer display, a telephone, a telephone head-set, and a connection with a database to receive account information associated with the remote terminal based on the remoteID.

16. A computing device at a service provider having instructions stored thereon that, when executed by a processor, cause the processor to perform operations comprising:
receiving data communications from a plurality of remote terminals via a wireless carrier, each data communication including a remote terminal identifier (“remoteID”) corresponding to the originating remote terminal;
selecting a call center to respond to each data communication based at least in part on the remoteID included in the data communication;
sending a message via a side-channel to the call center selected, the message including the remoteID;
receiving a voice communication from the call center responsive to the message, the voice communication received via a Public Switched Telephone Network (“PSTN”); and
routing the voice communication to a remote terminal associated with the message via the wireless carrier.

17. The computing device of claim 16, wherein sending the message to the call center selected comprises:
associating a temporary telephone number with the remoteID; and
sending the message to the call center, wherein the message includes the remoteID and the temporary telephone number.

18. The computing device of claim 17, wherein receiving the voice communication from the call center comprises:
receiving a phone call from the call center, the phone call addressed to the temporary phone number; and
associating the phone call with the message based on the temporary phone number used to address the phone call.

19. The computing device of claim 16, having the instructions stored thereon that, when executed by the processor perform further instructions comprising:
receiving a request from the call center via the side-channel, the request soliciting a telephone number to use in routing the voice communication to the remote terminal; and
sending a Temporary Local Directory Number (“TLDN”) to the call center responsive to the request, the TLDN to provide a communication route between the PSTN and the remote terminal.

20. A system at a service provider comprising:
means for receiving data communications from a plurality of remote terminals via a wireless carrier, each data communication including a remote terminal identifier (“remoteID”) corresponding to the originating remote terminal;
means for selecting a call center to respond to each data communication based at least in part on the remoteID included in the data communication;
means for sending a message via a side-channel to the call center selected, the message including the remoteID;
means for receiving a voice communication from the call center responsive to the message, the voice communication received via a Public Switched Telephone Network (“PSTN”); and
means for routing the voice communication to a remote terminal associated with the message via the wireless carrier.

21. The system of claim 20, wherein sending the message to the call center selected comprises:
means for associating a temporary telephone number with the remoteID; and
means for sending the message to the call center, wherein the message includes the remoteID and the temporary telephone number.

22. The system of claim 21, wherein receiving the voice communication from the call center comprises:
means for receiving a phone call from the call center, the phone call addressed to the temporary phone number; and
means for associating the phone call with the message based on the temporary phone number used to address the phone call.

23. The system of claim 22, wherein routing the voice communication to the remote terminal associated with the message comprises:
means for forwarding the phone call to the remote terminal using the temporary phone number, wherein the temporary phone number is incompatible with a North American Numbering Plan (“NANP”) convention.

24. The system of claim 20, further comprising:
means for receiving a request from the call center via the side-channel, the request soliciting a telephone number to use in routing the voice communication to the remote terminal; and
means for sending a Temporary Local Directory Number (“TLDN”) to the call center responsive to the request, the TLDN to provide a communication path between the PSTN and the remote terminal.
